(19) United States
(12) Patent Application Publication
(10) Pub. No.: US 2007/0136287 A1
(43) Pub. Date: Jun. 14, 2007

(54) METHOD FOR SORTING DATA FILES

(75) Inventors: Oliver Koster, Bielefeld (DE); Thomas Servatius, Herzebrock-Clarholz (DE); Oliver Wagner, Werther (DE); Thomas Dominikowski, Gutersloh (DE)

Correspondence Address: Henry M. Feiereisen;Henry M. Feiereisen, LLC, Suite 4714, 350 Fifth Avenue, New York, NY, 10118, US

(73) Assignee: Lycos Europe GmbH, Gutersloh (DE)

(21) Appl. No.: 11/557,677

(22) Filed: Nov. 8, 2006

(30) Foreign Application Priority Data
Nov. 8, 2005 (EP) 05 024 274.2

(51) Int. Cl. G06F 7/00

(52) U.S. Cl. 707/7

(57) ABSTRACT

In a method for sorting data blocks in a communications network having users, ratings of data blocks are stored in the network. The ratings are provided by network users and used to sort data blocks, so as to produce an assortment of data blocks reflecting an interaction among ratings provided by individual users.

### CROSS-REFERENCES TO RELATED APPLICATIONS

This application claims the priority of German Patent Application, Serial No. 05 024 274.2, filed Nov. 8, 2005, pursuant to 35 U.S.C. 119(a)-(d), the content of which is incorporated herein by reference in its entirety as if fully set forth herein.

### BACKGROUND OF THE INVENTION

The present invention relates to a method for sorting data or data blocks, respectively, in a communications network.

Nothing in the following discussion of the state of the art is to be construed as an admission of prior art.

Generally, it is possible for all network users to access a large amount of stored data and/or text and other types of data in a communication network. Search engines have been developed that enable the on-line users to selectively access data that is relevant to them. These search engines have functions that permit the user to define search terms used by filters to select data blocks. For example, these filters select the data blocks by examining blocks of data for a possible agreement between the search terms and corresponding terms within the data blocks.

The data blocks thus rated can be sorted so that they are ordered according to their respective relevance for the user. This sorting can be carried out according to the frequency of the search terms or the location of the search term in the data block, which is often a block of text. For example, if the corresponding term appears in the title of a text, this text has a greater relevance than one in which the term appears in a subordinate position, in the body of the text for example. Such sorting functions give an estimate of the relevance of the data blocks that have been identified.

Often those who provide the data blocks on a communication network (suppliers) are very concerned that their respective data blocks take the most conspicuous possible position in the list of ordered search results produced by such search engines. Suppliers design their data blocks to improve the position of their data blocks in such lists of search results. When an enormous number of common search terms appear in their data blocks, for instance, conventional search engines will then consistently assign such a data block a conspicuous place, one high on the list, and assigns such a data block an allegedly high relevance.

Unfortunately this artificial multiplication of search terms for the purpose of improving the position of the data block results in apparent and actual relevance being inconsistent. When users frequently encounter such results, the persuasiveness and even the usefulness of these distorted lists produced by conventional search engines suffers.

The present invention provides a method that produces an ordering of data or data blocks, respectively, that will, most likely, correspond to the relevance of that data or those data blocks.

### SUMMARY OF THE INVENTION

In accordance with the invention the data blocks in a communications network are rated by at least one network user and the rating is used by a search engine in sorting the data blocks so as to produce an answer to a search by a user to be produced on an output device of the communications network.

Of course, because previous ratings of particular data or data blocks by users in a communication network are used as the essential basis of the ordering of data and data blocks that is produced on the output device in response to a user's search, it is necessary that many users of the communication network are connected with another within the communication network.

In accordance with the invention, the sorted result produced by a search engine can be influenced by ratings received from users of the communication network and is not just determined by the supplier of a data block. Above all, this ordering of the search result is more strongly objective in that the user, and also other users, rate data blocks, especially in that one user rates the data block of a different user. Thus the persuasiveness of these sorted results that such a search engine provides to users is clearly improved.

In accordance with the invention, the users' “rating” of data blocks may be ranking or annotating or classification or a combination of these things. Ratings can be applied to data blocks by the users in various ways, either as individual ratings or in a combination of the different types, for example. In a particular embodiment, a data block is also evaluated by its author or by evaluating its author.

In a particular embodiment, user expertise is rated globally or for particular search topics.

In accordance with the invention, a member of a user group of the communication network may “rate” data blocks by assigning individual data blocks to a personal library. If the rated data blocks are stored in a data management system that is separate to the data management system on which the personal library is stored, this assignment can also be provided by a reference to the corresponding data blocks, whereby the reference only is saved on the data management system on which the personal library is stored, for example.

In a particular embodiment of the invention, the personal library or the assigned keywords are stored in one or more data bases.

In a further embodiment, a data block or a reference thereto can be rated by the user by assign it a value of a group of pre-defined rating-values or can be rated using arbitrarily chosen rating-values. In accordance with the invention, the rating can be done in addition to or as an alternative to rating using a value of a group of pre-defined rating-values or arbitrarily chosen rating-values by assigning at least one keyword to individual data blocks.

In a further embodiment, a first user of the communication network can obtain the rating of a respective second user, using keywords, for example. In that case, the search made by the first user is carried out using the values of that respective second user.

An advantageous embodiment of the present invention provides central storage for the ratings provided by individual users of the communications network, whereby the communications network can for example link the individual data manager devices of the users. These ratings can then be combined with each other so that the search result can be yet further improved.

In a preferred embodiment of the present invention, a personal rating may be provided to individual members of a user group within the communication network, to be assigned in accordance with their personal familiarity with a particular concept, for instance, and for these ratings of the users to be combined with ratings provided by these users.

According to the invention, the individual rating of the user can carried out in different ways. The rating can be orientated globally and independent of topics on the user itself, for example. It can, however, also vary from topic to topic. The global and the topic-specific rating can be combined. In the first case, the user is assigned a “global expert-rating”. Preferably, the value of this “global expert-rating” is selected from a predetermined number of different values of a “global expert-rating”. Depending on the assigned value of the “global expert-rating” the rating of a data block provided by the user with this assigned value can be weighed more in relation to a rating of a data block that has been provided by a user with a lesser value of the “global expert-rating”.

In the second case, the user is assigned a topic-specific rating. This can be different for different keywords or different fields of expertise. In this way, the ratings of the individual users can be weighed differently depending on the respective keyword or the respective field of expertise. In this way, a rating of a user can only really influence the search result, if the individual user has shown himself to be competent with the respective topic.

The two rating procedures of the users can be use independently or parallel. Combinations with all the other rating options are possible.

In a preferred embodiment the rating of the users is obtained through interaction of the individual users. This can for example be achieved in that a first user ask a topic-related question (which might be defined through a keyword or a field of expertise) and enters this question into the communications network. At least one second user give an corresponding answer to this question and enters this answer into the communications network. Depending on his answer, the user providing the answer is rated by the user asking the question. In this case, the rating preferably takes place keyword- or topic-related.

Alternatively or in addition the rating of a user can take place through direct rating through other users. This means: without questions and answers. This rating can take place “globally” (see above) or topic-related. The rating can take place actively, for example through a “recommendation” of this user through a different user, that already has an “expert rating”. The rating can also take place inactively, for example in that one user permanently watches the data blocks of a different user and thereby inactively assigns to him an “expert rating”.

In addition, the data blocks can be sorted using data-specific criteria. For example, data or information blocks can additionally be rated by the frequency of individual search terms. Alternatively, or in addition, the data blocks can be sorted by the frequency with which they have been requested heretofore within the communication network.

Clearly this provides an optimization of the persuasiveness of the resulting listing of data blocks.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is schematic diagram of a first embodiment of the present invention; and

FIG. 2 is schematic diagram of a second embodiment of the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

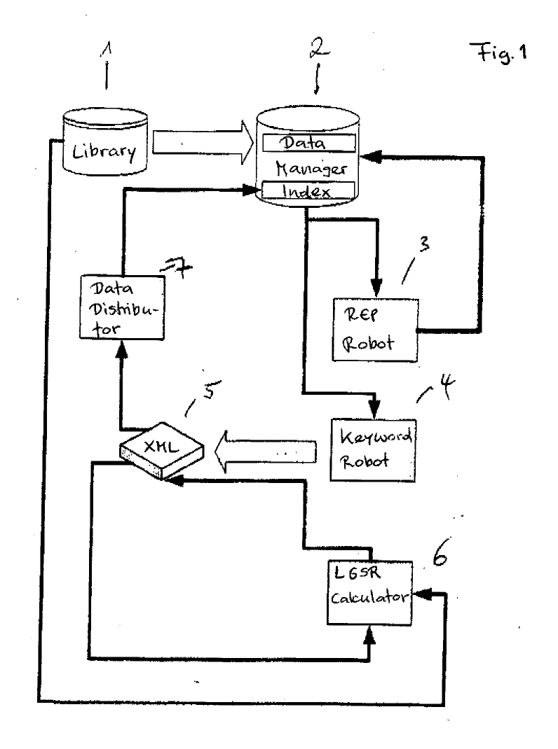

In FIG. 1, information pertaining to data blocks in a plurality of different databanks is stored in the data library of a knowledge community database 1, among other things. This information includes, among other values, a rating provided by the users of the communications network.

The individual data blocks are indexed and the index thus produced is copied into a search engine database that forms a part of a data manager device 2. The indicated data blocks are first tested by a first scanner, for example an REP (Robots Exclusion Protocol) robot 3. None-applicable data blocks are hereby filtered out of the index. From the data blocks that remain in the index after the filter, keywords are thereafter filtered out by a further filter robot 4. The keywords are assigned to the individual data blocks.

In a subsequent step, given elements of the individual data blocks, for example addresses by which the data blocks themselves can be accessed and/or the assigned keywords, are filed in an XML (extensible Mark-up Language) data storage system 5 of the data manager device.

The data blocks as represented by the components filed in the XML data storage system 5 are then rated via a rating system (LGSR (Link Quality Criteria creation by Specialist Ranking) calculator 6), for example by being matched with the library copy of the individual data block. They are then supplied to the data base again by a data distributor 7.

The data base modified in this way now provides the basis for a search function (search engine) that user can conduct. The data blocks stored in various data banks can be searched using search terms, whereby the result is presented as weighed sorting of the search hits.

In accordance with the method of the invention, the search result is weighted by ratings that individual users assign to particular data blocks. Hence, the experiences of the user regarding the rated data blocks can influence the search result of another user in an automatic manner.

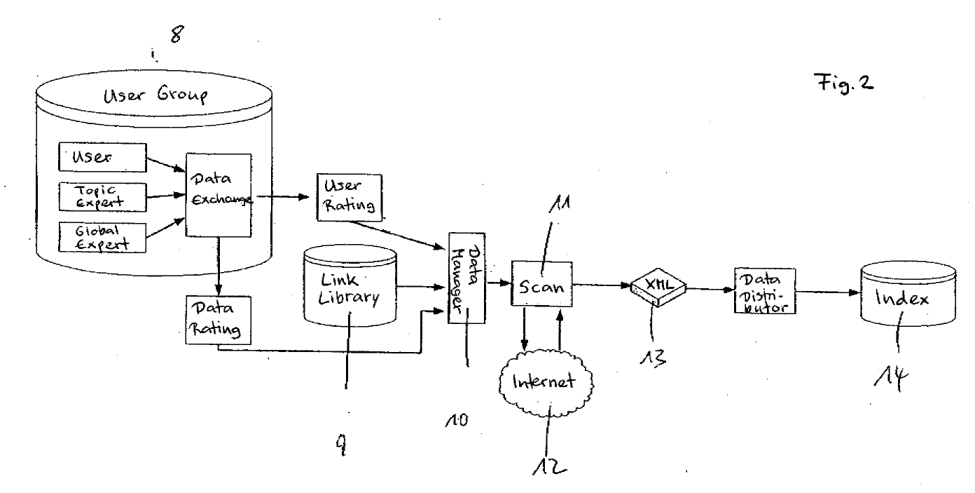

FIG. 2 shows an alternative embodiment of the present invention that resorts to a further rating of the users generated by the interaction of the users of the communication network.

Through the interaction of a plurality of communication network users using various rating methods: question and answer, expert network, and social book marking, for example, by interaction through direct information exchanges, for example, creates ratings for individual users, which in the cause are recognized as having “Expert” ratings. Each such user rated as an “Expert” user holds a global “Expert” rating and/or one or more subject-specific “Expert” ratings. In FIG. 2 reference numeral 8 indicates a user group.

The ratings of users as well as their rating of data blocks accessed are stored in a special data bank, the link library 9, and are brought together in the data manager device 10.

Data blocks stored in individual databanks, here represented as a data bank source such as the internet 12, are automatically searched by a scanner robot 11, and keywords are filtered out from the respective data block by any one of the methods that are well-known in the art, the keywords giving a summary of the contents of each of the respective data blocks.

These summaries, as well as particular elements of the individual data blocks, like the addresses under which the data blocks themselves are accessible, for example, are filed in an XML data storage system 13 of the data manager device 10.

In this embodiment, the users of the communication network 12 can obtain the information filed in the XML data system 13 of the data manager device 10, in the form of a weighted search result from the search engine index 14, using a search function corresponding to a search request made by a user.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for sorting data blocks in a communications network having users, said method comprising the steps of:
storing ratings of data blocks in the network, said ratings being provided by network users;
using ratings provided by the users to sort the data blocks, so as to produce an assortment of data blocks reflecting an interaction among users.

2. The method of claim 1, wherein at least one user assigns data blocks to a personal library.

3. The method of claim 1, wherein at least one user assigns at least one keyword to at least one data block.

4. The method of claim 1, wherein personal libraries are stored by at least one data management device.

5. The method of claim 1, wherein assigned keywords are stored by at least one data management device.

6. The method of claim 1, wherein the users receive ratings and these user ratings influence the sorting of data blocks.

7. The method of claim 1, wherein the users are rated globally.

8. The method of claim 1, wherein the users are rated for individual search topics.

9. The method of claim 1, wherein data blocks can be sorted using a data-specific criterion.

10. The method of claim 7, wherein data or information blocks are additionally rated by the frequency of individual search terms.

11. The method of claim 7, wherein data blocks are additionally sorted by the frequency with which they have been requested heretofore within the communication network.

12. The method of claim 1, wherein the ratings are not provided by the author of the respective data block.

13. The method of claim 1, wherein the ratings include a rating of the author of the respective data block.

14. The method of claim 1, wherein data blocks are rated by being assigned to a personal library.

15. The method of claim 14, wherein the data blocks are stored on a data management device that is spatially separate from the data management device on which the personal library is stored, and only a reference to a data block assigned to the personal library is stored on the data management device on which the personal library is stored.

16. The method of claim 1, wherein the ratings of individual users that interact with each other are ratings of data stored on a plurality of data management devices, the ratings being stored on a device that is central to the plurality of data management devices so that these ratings can be combined with each other in the search output.

17. The method of claim 2, wherein the personal library is stored in a plurality of data bases.

18. The method of claim 3, wherein the assigned keyword is stored in a plurality of data bases.

19. The method of claim 1, wherein a data block is assigned a rating value from a group of pre-defined rating values.

20. The method of claim 19, wherein a data block is also assigned at least one keyword.

21. The method of claim 1, wherein a data block is assigned an arbitrary rating value.

22. The method of claim 21, wherein the data block is also assigned at least one keyword.

23. The method of claim 1, wherein the result of a search result requested by a first user is selectably sorted using the rating assigned by a given second user.

24. The method of claim 23, wherein the rating assigned by the given second user is weighted in accordance with the second user's familiarity with a particular field of expertise.

25. The method of claim 23, wherein the rating assigned by the given second user is weighted in accordance with the second user's familiarity with a particular key word.

26. The method of claim 23, wherein the first user interacts with other users by requesting an answer to at least one topic-related question entered into the communications network and selects the first user, and the first user selects a second user in response to answers other users provide to the question.

27. The method of claim 26, wherein the topic is a particular field of expertise.

28. The method of claim 23, wherein the topic is a particular keyword.

29. The method of claim 23, wherein a third user having an expert rating interacts with the first user by recommending the second user.

30. The method of claim 23, wherein a third user having an expert rating interacts with the first user by assigning an expert rating to the second user.

31. A method for sorting data blocks in a communications network having users, said method comprising the steps of:
storing ratings of respective data blocks provided by a plurality of individual network users;
providing interaction among individual network users;
sorting data blocks so that interaction among individual network users influences a sorting of respective data block produced by an output device.

32. A method for sorting data blocks in a communications network having users, said method comprising the steps of:
storing ratings for a plurality of data blocks in the network, respective ratings being provided by network users for respective data blocks;
using ratings provided by more than one of the network users for at least one of the data blocks to sort the data blocks, so as to produce an assortment of data blocks reflecting an interaction among network users.
